(19) United States
(12) Patent Application Publication
(10) Pub. No.: US 2006/0219262 A1
(43) Pub. Date: Oct. 5, 2006

(54) Water fill level control for dishwasher and associated method

(76) Inventors: Gregory A. Peterson, South Barrington, IL (US); Thomas J. Sheahan, Cary, IL (US)

Correspondence Address: HARNESS, DICKEY & PIERCE, P.L.C., P.O. BOX 828, BLOOMFIELD HILLS, MI, 48303, US

(21) Appl. No.: 11/098,124

(22) Filed: Apr. 4, 2005

(51) Int. Cl. B08B 7/04; B08B 9/20; B08B 3/00; B08B 3/12

(52) U.S. Cl. 134/18; 134/25.2; 134/56 D; 134/58 D; 134/184

(57) ABSTRACT

A control device and method for detecting and controlling a water fill level in a dishwasher or other similar appliance that includes a pump motor is provided. The control monitors the pump motor current over time, determines a current change, and compares the current change to a threshold current change that is indicative of the water level.

### FIELD OF THE INVENTION

The present invention relates to an apparatus and method for controlling the water fill level of a household appliance such as a dishwasher.

### BACKGROUND OF THE INVENTION

Household appliances like dishwashers conventionally control water fill into the appliance by opening and closing an electronically operated water valve, such as a solenoid actuated valve, over a predetermined time period. Consequently, the volume of fluid passing through the valve (and hence into the appliance) can be calculated as a function of the time that the valve is open. When a desired water fill is obtained in the appliance, the valve is closed.

Household water line pressures can vary significantly, however. In order for conventional dishwasher controls to provide the desired water fill, the water valve controlled by the appliance generally includes a pressure compensating insert (e.g., a washer) that produces a known fluid flow rate through the valve. Pressure compensating inserts, though, are known to wear and degrade over time, such that a reliably repeatable water fill cannot be maintained. Eventually, the water fill in the appliance is other than the desired water fill that is intended to achieve efficient and effective dish washing performance. For example, the water level may be too low or too high. A low water level does not provide the dishwasher pump with an adequate volume of water for effective washing. Further, the water level may be so low as to create a “dry pump” condition, in which the appliance has practically no water. Operation of the appliance under a dry pump condition can damage various components of the appliance, including the pump and motor. Alternatively, a high water level increases hot water consumption above that necessary for effective dish washing performance and wastes both hot water and energy.

It is also known that during the operation of the appliance the amount of usable water from the initial water fill may change. A low water level detected during subsequent operation of the appliance may be indicative of the failure of dishwasher components or a leak. In addition, in a dishwasher it is not uncommon for a bowl or cup to overturn during operation of the appliance. Once overturned, the bowl typically accumulates water, leaving less water to be circulated throughout the dishwasher. Thus, although a desired amount of water was introduced into the appliance initially, an insufficient amount of water remains for effective washing. Similarly, debris and dirt in the water can also affect the volume of water necessary for effective washing. To avoid such low water conditions, it is not uncommon for conventional dishwashers to regularly fill the dishwasher to a higher water fill than is necessary for effective dish washing. While reducing the risk of poor dishwashing performance, this practice increases hot water consumption and wastes water and energy.

It is desirable, therefore, to provide a water fill control that provides an optimal water fill to the appliance and maintains the optimal fill during its operation to thereby ensure adequate and efficient cleaning without the unnecessary use of water or energy.

### SUMMARY OF THE INVENTION

The invention provides a control device and method for detecting and controlling a water fill level in a dishwasher or other similar appliance that includes a pump motor. The control device senses and measures the current drawn by a pump motor, determines the difference between the maximum value and minimum value of the measured current over a time interval, and compares the difference to a threshold value that is indicative of a desired, optimal water fill level. The optimal water fill level is substantially the minimum amount of water that is necessary for effective dishwashing performance without wasting water and/or the energy required for heating an additional and unnecessary water volume. The optimal water level reduces water waste and energy inefficiencies associated with using and heating more water than is necessary for operation of the appliance.

The detected water fill level can include a low water fill level, a dry pump condition, or an optimal water fill level.

If the detected water fill level is other than desired, corrective action can be taken as needed by controlling the operation of the appliance, for example, operating a water valve that provides water to fill the dishwasher. Accordingly, the water fill level in the dishwasher can be controlled such that an optimal water level is maintained throughout the operation of the dishwasher.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic representation showing an exemplary dishwasher including the water fill level control according to the present invention;

FIG. 2 is a graphical representation of pump motor current versus time in a dishwasher having a low water fill level.

FIG. 3 a graphical representation of pump motor current versus time in a dishwasher having an optimal water fill level; and

FIG. 4 is an exemplary flowchart illustrating a method of water fill level control according to the invention;

### DETAILED DESCRIPTION OF PREFERRED EMBODIMENTS

The following description of preferred embodiments is merely exemplary in nature and is in no way intended to limit the invention, its application, or uses.

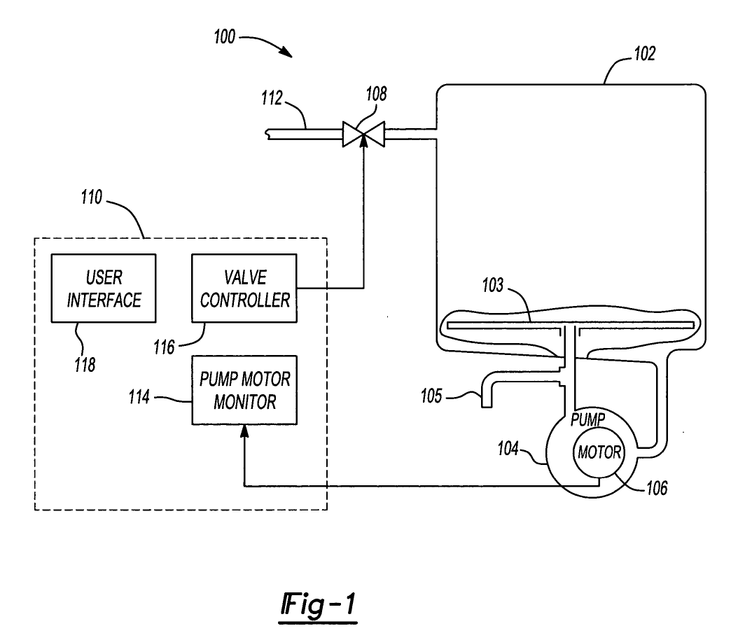

FIG. 1 diagrammatically illustrates an exemplary dishwasher 100 incorporating a water fill level control according to the invention. As shown, the dishwasher 100 generally includes a dishwasher tub 102, a pump 104 coupled to a pump motor 106, an electronically-controlled water valve 108 and a control device 110 for controlling the operation of the appliance, including the water fill.

As is known, the dishwasher tub 102 provides a closed chamber into which dishes and the like to be washed are loaded. The dishwasher tub 102 includes a water circulation system including spray arms 103 that distributes water throughout the dishwasher tub 102. The pump motor 106 drives the pump 104, which, for example, forces wash and/or rinse water under pressure through the spray arms 103 of the dishwasher 100. The pump 104 is also operable to evacuate water from the dishwasher tub 102 into a drain 105.

The electronically-controlled water valve 108 is coupled to a household water supply line 112. The water valve 108, as operated by the control device 110, opens and closes to manage the flow of water into the dishwasher tub 102.

The control device 110 controls the water fill level operation of the dishwasher 100. The control device 110 generally comprises a pump motor monitor module 114, a valve controller module 116, and a user interface module 118. The term “module,” as defined herein, can include an application-specific integrated circuit (ASIC), an electronic circuit, a processor (shared, dedicated, or group) and memory that execute one or more software or firmware programs, a combinational logic circuit, and/or other suitable components that provide the water level detection and control functionality for the dishwasher 100, as described herein.

The pump motor monitor module 114 monitors the activity of the pump motor 106 to obtain a signal indicative of the current I drawn by the pump motor 106. The control device 110 of the invention utilizes the measurements of the pump motor current I over time to detect and control the water fill level in the dishwasher 100 during operation of the appliance. Alternatively, the pump motor monitor module could be configured to monitor other operating conditions of the pump motor, such as the pump motor power (P) or the pump motor current phase angle (α) in a similar manner. In the discussion that follows, however, reference is made only to monitoring pump motor current I.

The water fill level in a dishwasher 100 can be, for example, a “low” water fill level, in which the pump 104 is not provided with adequate water volume for effective washing performance. In circumstances of extremely low water fill levels, a “dry pump” condition occurs whereby practically no water is provided to the pump 104, and damage to various components of the dishwasher 100 can result with continued operation. Additionally, the water fill level can be “optimal,” where an adequate water volume for efficient cleaning performance is provided and maintained in the appliance. The optimal water fill level is substantially the minimum water volume that is practicable for effective cleaning without over-filling and wasting water and/or energy associated with heating additional and unnecessary water volume. The optimal water fill level, therefore, reduces water waste and energy inefficiencies in the appliance.

It will be appreciated that detecting and preventing or correcting a low water fill level or a dry pump condition in the dishwasher 100 provides several advantages. By providing an initial optimal water fill and then adding water during operation of the appliance only as needed, effective cleaning performance is maintained in the appliance, while efficiencies associated with minimizing hot water use and conserving energy are realized. Thus, there is no need to provide an initial “estimated” water fill based on water flow through the water valve 108 for a pre-determined fixed time interval. Consequently, the occurrences of over-filling or under-filling and not achieving the optimal water level required for effective cleaning performance and hot water/energy conservation are avoided. The present invention provides the ability to obtain a practicable optimal water fill level that can be maintained throughout the operation of the appliance by continuously monitoring the pump motor current I and taking appropriate preventive or corrective action, as necessary thereafter.

The pump motor 106 uses electricity to drive the pump 104 which, in turn, circulates and distributes water throughout the dishwasher tub 102. The pump motor's 106 power and current consumption can be used to detect and control the water fill level in the appliance. More particularly, the pump motor 106 generally exhibits fluctuations and/or surges in its power and current consumption when the appliance is operating with a water circulation system that has a less than an optimal water fill level. By monitoring any such fluctuations and/or surges, the invention can control the supply of water to the appliance to ultimately achieve an optimal water fill level. Similarly, the phase angle (α) of the pump motor current (as referenced to an AC line voltage) exhibits changes as the load on the pump motor fluctuates.

For example, when the water fill level is too low, there is not enough water in the appliance to keep up with the operation pump 104. As a consequence, air is periodically drawn into the appliance's water circulation system causing the pump 104 to cavitate. In such instances, pump cavitation generally continues until the water that has been distributed throughout the dishwasher tub 102 replenishes the water circulation system. The cycle then repeats. In such instances, cleaning performance of the appliance is noticeably degraded.

During the periods of pump cavitation, the current drawn by the pump motor 106 is measurably lower. The pump motor's 106 current draw increases when the pump 104 is not cavitating. FIG. 2 shows an exemplary graph that plots the pump motor current versus time in the case of a low water fill level in a dishwasher. As shown in FIG. 2, there is an initial current peak Iₚₖ at motor start-up. After an initial start-up time delay t_{d}, the pump motor current exhibits a repetitive cycle 200 of a duration Δt. The current cycle 200 exhibits significant current fluctuations between an current minimum Iₘᵢₙ and a current maximum Iₘₐₓ., The value of the change in current between the minimum current Iₘᵢₙ and the maximum current Iₘₐₓ in one cycle is represented as ΔI. In the example of FIG. 2, the change in current ΔI is about 4.5 amps (i.e., about 6 amps minus about 1.5 amps) in a cycle where Δt is about four seconds, after an initial start-up time t_{d} of about two seconds.

The times during the current cycle 200 when the pump motor current is at its minimum Iₘᵢₙ represent the times when the pump is cavitating. Conversely, at the times in the current cycle 200 when the pump motor current is at its maximum Iₘₐₓ, the pump is not cavitating and is operating normally, pumping water throughout the water circulation system of the appliance.

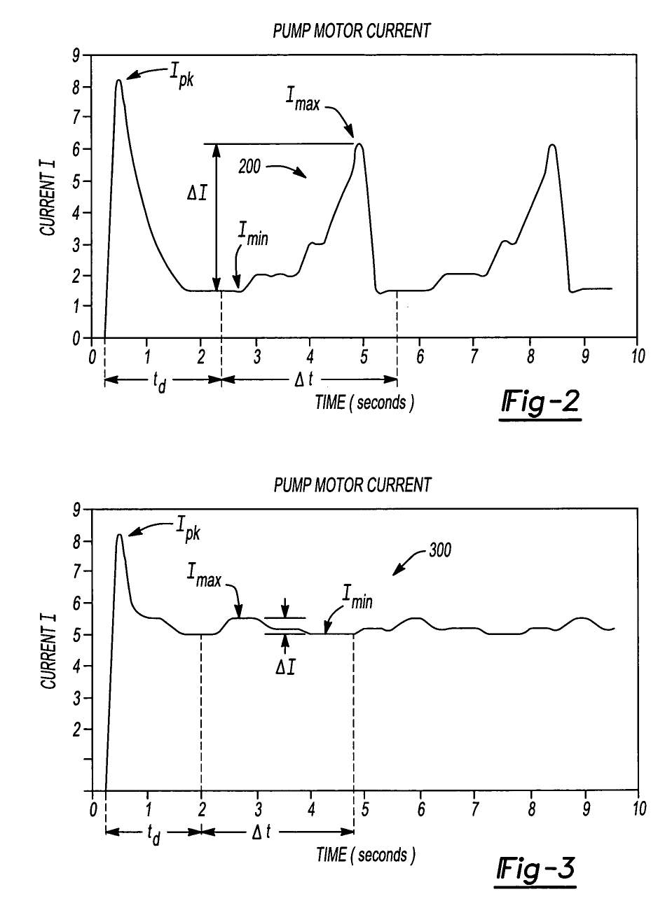

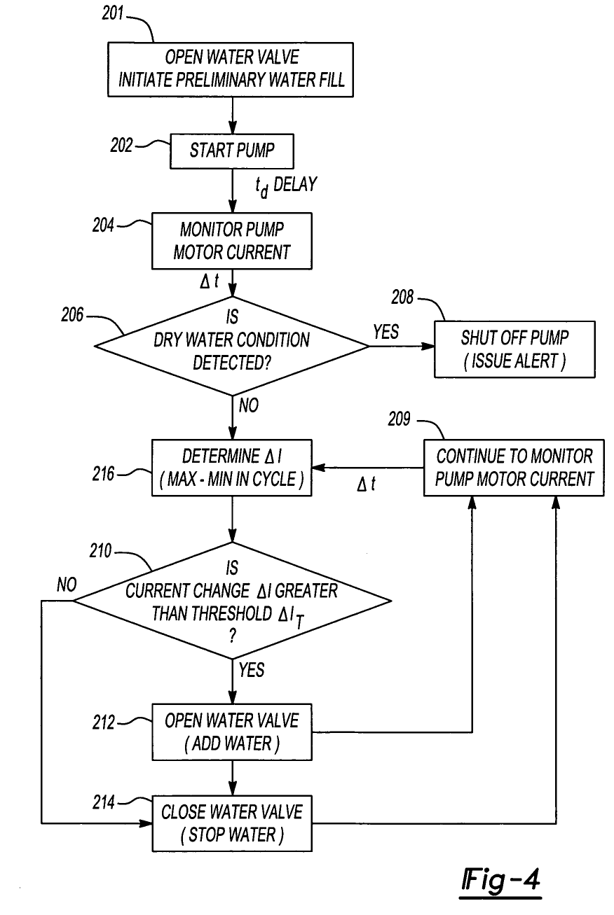

By comparison, FIG. 3 shows an exemplary graph plotting pump motor current versus time in the case where the water fill level is at or above the level in which there is no pump cavitation during the operation of the same appliance. As illustrated, an initial current peak Iₚₖ occurs during the pump motor start-up, similar to that shown in FIG. 2. Also similar to the example shown in FIG. 2, after an initial start-up time t_{d}, the current peak Iₚₖ is followed by a substantially regular current cycle 300 of a duration Δt. The current cycle 300 does not yield a constant current, but instead exhibits small current fluctuations ΔI between current maximums Iₘₐₓ and minimums Iₘᵢₙ. In the example illustrated in FIG. 3, the value of the change in current between the minimum current Iₘᵢₙ and the maximum current Iₘₐₓ in one cycle ΔI is significantly less than 1 amp. It is understood by a person having ordinary skill that the time t_{d}, the current peak Iₚₖ, and the current cycle 300 are characteristics dependent on the particular model of an appliance (e.g., the particular pump, pump motor, dishwasher features, etc.). Though these characteristics may vary between different models of appliances, they are generally consistent within the same appliance model.

A dry pump condition can be detected when current surges are substantially absent but the current I remains substantially at the minimum current level Iₘᵢₙ after the initial time delay t_{d}. Operating the pump 104 under a dry pump condition can damage the pump, various pump seals and other parts. Accordingly, upon detection of a dry pump condition, corrective action can include shutting off the pump 104 and pump motor 106 and/or issuing a visual or audible alert to the user via the user interface module 118.

Therefore, the characteristic of ΔI in the current cycle of the pump motor can provide a reliable indicator as to whether the appliance has a water fill level that provides for effective dishwashing performance. A threshold current change ΔI_{T}, then, can be established for any given appliance model that can, in turn, be used by an appliance controller to control the water fill level in the appliance to achieve an optimal water fill level.

More particularly, the current I of the pump motor is monitored as the dishwasher is being filled with water. From the current measurements a maximum current change over a current cycle is determined. The maximum current change is then compared to a threshold current change that is representative of an optimal water fill level for that appliance. During water fill, when the maximum current change is less than or equal to the threshold current change, then an optimal water fill level has been achieved and water flow into the dishwasher can be stopped. The current monitoring and comparison continues during the operation of the appliance. Should the maximum current change rise above the threshold current change, then water flow into the dishwasher can be restarted until the maximum current change again becomes less than or equal to the threshold current change.

Referring to FIG. 4, an exemplary method for controlling the water fill level in an appliance according to the invention is illustrated in the flowchart. An initial preliminary water fill of the appliance is initiated at block 201. The appliance's pump 104 and pump motor 106 are started at block 202. After an initial time delay t_{d}, the current I drawn by the pump motor 106 is measured at block 204.

The measured current is first compared to a dry pump condition value at block 206 to determine whether the appliance is exhibiting a dry pump condition. If a dry pump condition is detected, then the pump 104 and pump motor 106 are shut off and/or an alert is issued to the appliance user at block 208.

If a dry pump condition is not detected at block 206, the current continues to be monitored for a time period Δt at block 209. At the end of the time period Δt, the change in the current ΔI over the time period Δt is determined at block 216.

The change in current ΔI is then compared with a threshold current change ΔI_{T} for the appliance at block 210. If the change in current ΔI is greater than the threshold current change ΔI_{T}, then it is determined that the appliance has a low water level and the water valve to the appliance remains open so water continues to fill the appliance. The pump motor current I continues to monitored at block 209.

As blocks 209, 216 and 210 repeat, there will come a point in the normal operation of the appliance where, at block 210, the change in current ΔI will be less than or equal to the threshold current change ΔI_{T}. At this time, then, it is determined that the appliance has an optimal water fill level. In such a case, the water valve 108 is closed at block 214, shutting off the water to the appliance. Again, current monitoring continues at block 209.

If, at any time during the operation of the appliance, the change in current ΔI rises above the threshold current change ΔI_{T}, the water valve will be opened to allow more water to enter the appliance, until an optimal water fill level is again reached.

Accordingly, the control device 110 is operable to monitor the current draw from the pump motor 106 by receiving a signal indicative thereof, and process the signal to determine whether the water fill level in the dishwasher tub 102 is optimal, low, or in a dry pump condition. Based on the water fill level, the control device 110 can subsequently control the opening and closing of the water valve 108 to achieve the optimal water fill level, which is substantially the minimum water level that is practicable for effective cleaning performance without wasting water and/or energy for heating an additional unnecessary water volume, or at least reduce water and energy inefficiencies.

Detecting and correcting or preventing a low water fill level or dry pump condition in the dishwasher 100 according to the invention provides several advantages. By adding water as needed, effective cleaning is maintained, while efficiencies associated with conserving water and energy are realized. There is no need to provide an estimated water fill based on a pre-determined fixed time interval, which increases the risk over filling or under filling and not achieving the optimal water level required for effective cleaning performance and water and energy conservation. In particular, a practicable optimal water level can be maintained by continuous monitoring of the pump motor current and taking appropriate corrective or preventive action.

While various embodiments and aspects of the invention have been described, it will be apparent to those of ordinary skill in the art that other embodiments and implementations are possible that are within the scope of this invention. Accordingly, the invention is not restricted except in light of the attached claims and their equivalents.
What is claimed is:

1. A method for detecting a water fill level in a dishwasher having a pump powered by an electric pump motor, the method comprising:
monitoring an electric current drawn by pump motor over a time period;
determining a difference between a maximum pump motor current and a minimum pump motor current occurring during the time period; and
comparing the difference to a threshold value that is indicative of the water fill level in the dishwasher.

2. The method of claim 1, further comprising adjusting the water fill level when the difference exceeds the threshold value.

3. The method of claim 2, wherein adjusting the water fill level comprises controlling the flow of water into the dishwasher.

4. The method of claim 1, further comprising disabling the pump motor if the pump motor current is indicative of a dry pump condition.

5. The method of claim 4, further comprising alerting a user of the dishwasher if the pump motor current is indicative of a dry pump condition.

6. A method for controlling a water fill level in a dishwasher having a pump driven by a pump motor, the method comprising:
monitoring a current drawn by the pump motor over time;
determining a difference between a first pump motor current and a second pump motor current;
comparing the difference to a value indicative of an optimal water fill level; and
controlling the water flow into the dishwasher to cause the difference to be less than or equal to the value.

7. The method of claim 6, wherein determining a difference between a first pump motor current and a second pump motor current comprises determining a maximum pump motor current in a time period, determining a minimum pump motor current in the time period, and determining a difference between the maximum pump motor current and the minimum pump motor current.

8. The method of claim 6, wherein controlling water flow into the dishwasher comprises opening or closing a water valve coupled to a water supply and the dishwasher.

9. The method of claim 6, wherein the value indicative of an optimal water fill level comprises at least the difference between the maximum current and the minimum current drawn by the pump motor over a time period under water fill level conditions in the dishwasher where the pump does not cavitate.

10. The method of claim 6, further comprising determining whether the pump motor current is indicative of a dry pump condition.

11. The method of claim 10, further comprising disabling the pump motor if the pump motor current is indicative of a dry pump condition.

12. The method of claim 11, further comprising alerting a user of the dishwasher if the pump motor current is indicative of a dry pump condition.

15. A control device for controlling the water fill level in an appliance having a pump and an electric pump motor, the control device comprising:
means for monitoring the electric current drawn by the pump motor;
means for determining a difference between a first pump motor current value and a second pump motor current value;
means for comparing the difference to a value indicative of an optimal water fill level in the appliance; and
means for controlling the water flow into the dishwasher to cause the difference to be less than or equal to the value.

16. The control device of claim 15, wherein the means for determining a difference between a first pump motor current value and a second pump motor current value comprises:
means for determining a maximum pump motor current and a minimum pump motor current in a time period; and
means for determining a difference between the maximum pump motor current and the minimum pump motor current.

17. The control device of claim 15, wherein the means for controlling water flow into the dishwasher comprises an electromechanical water valve coupled to a water supply and the dishwasher and a valve controller operable to selectively open or close the water valve.

18. The control device of claim 15, wherein the value indicative of an optimal water fill level comprises at least the difference between the maximum current and the minimum current drawn by the pump motor over a time period under water fill level conditions in the appliance where the pump does not cavitate.

19. The control device of claim 15, further comprising means for determining whether the pump motor current is indicative of a dry pump condition.

20. The control device of claim 19, further comprising means for disabling the pump motor if the pump motor current is indicative of a dry pump condition.

21. The control device of claim 20, further comprising means for alerting a user of the dishwasher if the pump motor current is indicative of a dry pump condition.

22. A dishwasher comprising:
a tub;
a pump;
an electric motor driving the pump;
a valve for controlling water flow into the tub; and
a control device for controlling the water fill level in the dishwasher comprising:
means for monitoring the electric current drawn by the motor;
means for determining a difference between a first current value and a second current value;
means for comparing the difference to a value indicative of an optimal water fill level in the dishwasher; and
means for operating the valve to cause the difference to be less than or equal to the value.

23. A control device for controlling the water fill level in an appliance having a pump and an electric pump motor, the control device comprising:
a pump motor monitor module that monitors the value of an operating condition of the pump motor over time and compares the value to a reference value indicative of an optimal water fill level in the appliance; and
a valve controller module that controls the water flow into the dishwasher such that the value approximates the reference value.

24. The control device of claim 23 wherein the operating condition of the pump motor is one of the current drawn by the pump motor, the power drawn by the pump motor, and the phase angle of the pump motor.
